(19) United States
(12) Patent Application Publication
(10) Pub. No.: US 2006/0282277 A1
(43) Pub. Date: Dec. 14, 2006

(54) In-Transit Shipment Re-Direction Service for Reduced Shipping Latencies

(75) Inventor: David Way Ng, Redwood City, CA (US)

Correspondence Address: STUART T AUVINEN, 429 26TH AVENUE, SANTA CRUZ, CA, 95062-5319, US

(73) Assignee: David Way Ng, Redwood City, CA (US)

(21) Appl. No.: 11/160,226

(22) Filed: Jun. 14, 2005

(51) Int. Cl. G06Q 99/00

(52) U.S. Cl. 705/1

(57) ABSTRACT

A shipping redirection interface allows a seller to change the destination address while a package is in-transit. The seller orders a product from a low-cost overseas factory, inputs the seller's address as an initial destination and begins shipment on a slow container ship. A schedule generator calculates an optimistic estimate of the package's arrival at the intermediate hub that redirects the package so the seller can plan when to redirect. While the product is slowly crossing an ocean on the ship, the seller may sell the product to a buyer such as through an online auction. The seller enters the buyer's address as the new destination address and redirects the product at the intermediate hub after the product is unloaded from the ship. The delay from sale to the buyer until the buyer receives the product is reduced without warehousing the product. Unsold products are delivered to the seller.

### FIELD OF THE INVENTION

This invention relates to shipping systems, and more particularly for methods for re-directing shipments in transit.

### BACKGROUND OF THE INVENTION

Products are often manufactured in countries far away from the buyer to take advantage of lower production costs. While products could be shipped by air, this may increase the cost and offset some of the overseas cost savings. Products that are shipped by sea often experience significant delivery delays since a container ship may require a week or more to traverse the Pacific Ocean.

Products made overseas are often stored in a warehouse near the buyer, or at least in the same country as the buyer. This requires that the products be shipped to the warehouse before the buyer purchases the product. This significantly reduces the buyer's wait for the product since the product may be re-shipped from the warehouse to the buyer after the buyer completes the purchase.

However, storing products in warehouses adds inventory costs. Various middlemen may further increase costs. Just-in-time manufacturing methods try to reduce or eliminate this warehouse or inventory cost by scheduling parts to arrive at a factory just before they are needed for production. While this is useful for predictable, relatively-constant-demand applications such as assembly lines, consumer demand can be too fickle for such an approach to be useful for products being sold and shipped to consumers. Just-in-time delivery methods may work for factories, because the factory's address is known, allowing parts to be scheduled to arrive at the factory. On the other hand, a consumer's address is not known until the sale is completed, so the product is not shipped until the consumer's address is available.

While warehousing of smaller-size and more expensive products may be practical, for large products such as furniture and very low cost products the cost of warehousing can be a significant fraction of the overall cost. For example, low-cost furniture made in China may require that the consumer wait for 2 or more week after ordering and purchasing the furniture before it arrives at his house, due to the slow speed of container ships from China to the U.S. Furniture made in China but stored in a U.S. warehouse before the buyer places an order can be delivered in a few days, but is more expensive than direct-shipped furniture.

Shipping services such as Fedex and United Parcel Service (UPS) have online interfaces to their computerized shipping and tracking systems that allows consumers to keep track of their shipments while in transit. UPS allows the recipient to leave a note on the door to forward the package to another address, such as a neighbor next door, or to redirect the package using an on-line interface after the package arrives. These systems may even allow the destination address to be corrected while the shipment is in transit, such as when a mistake is made in the address. The customer may telephone the shipping service to request a change from a customer-service person receiving the telephone call. Shippers may charge a redirection fee to change the address on a package in transit when the consumer has entered an incorrect address.

It is desirable to reduce warehousing costs using innovative shipping methods. It is desirable to reduce shipping delays to the buyer without warehousing products. It is desirable to use slower shipping methods to reduce shipping costs.

### BRIEF DESCRIPTION OF THE DRAWINGS

FIG. 1 is a diagram of overseas shipping links.

FIG. 2 is a shipment route diagram showing re-direction at different hubs.

FIGS. 3A-C show shipment timelines with and without package re-direction.

FIG. 4 shows a carrier interface to a network of carriers.

FIG. 5 shows a shipment management system that supports in-transit package re-direction.

FIG. 6 shows a re-direct shipment display page.

FIG. 7 is a flowchart of a shipping process without redirection.

FIG. 8 is a flowchart of an in-transit redirection process.

### DETAILED DESCRIPTION

The present invention relates to an improvement in shipment management systems. The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The inventor has realized that shipment management systems allowing a package to be re-directed to an alternate address may also be used to reduce shipment delays to a purchaser. A seller may enter his own address, or an address of a warehouse, as the initial address for a product shipped from an overseas location. The product is loaded on a container ship and begins its long journey. Before the product arrives in a U.S. port, the product is sold to a buyer by the seller. The seller then enters the buyer's address as the re-directed address. Once the package arrives in a U.S. port, it is re-directed to the buyer's address.

Although the total shipping time from the overseas factory is the same, the delay seen by the buyer is reduced. In-transit shipment re-direction allows the product to be re-directed to the buyer after the sale is made, although the shipment begins transit before the purchase is made.

If no purchase is made, the product is shipped to the initial address. The seller may then pay warehousing costs until the product is actually sold. High-demand products with many potential buyers, or products with predetermined end-of-sale dates, such as those sold by auction on eBay, can especially benefit from this re-direction method.

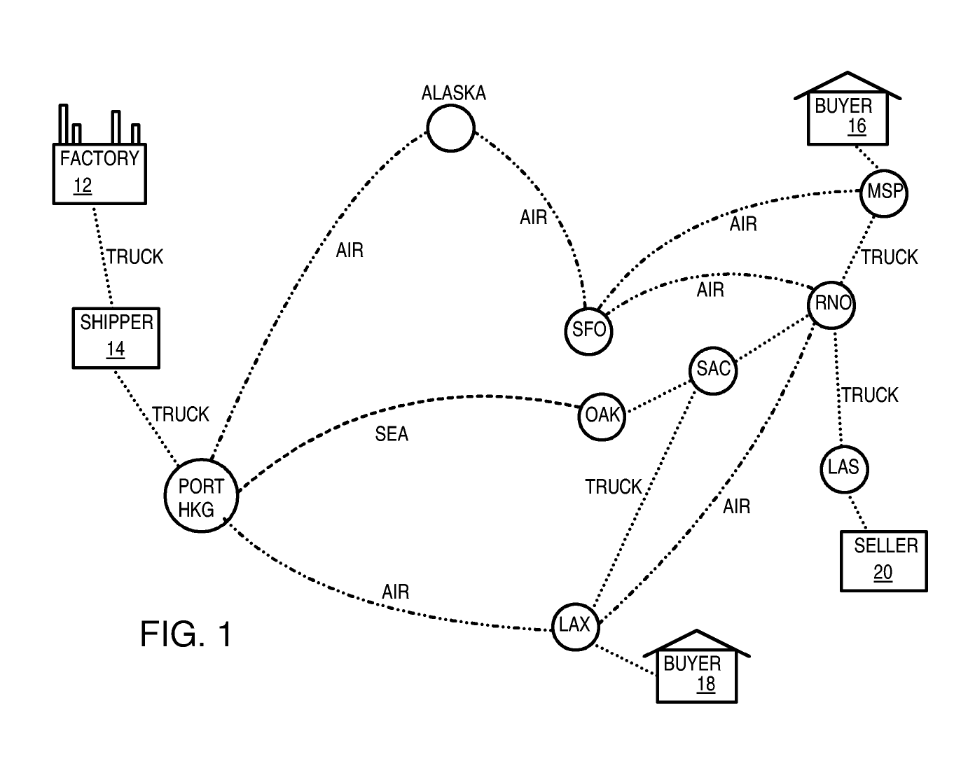

FIG. 1 is a diagram of overseas shipping links. Factory 12 is in a low-cost country such as China and produces a product that is shipped by truck to shipper 14. Shipper 14, which may be a broker or middleman that works with or for factory 12, sells the product to seller 20 in Las Vegas, Nev. (LAS). The product is packaged and shipped to an initial address of seller 14 in LAS. The seller may actually reside elsewhere, but may contract with a warehouse in LAS to receive products that are not sold while in transit.

Shipper 14 ships the product by boat from Hong Kong (HKG) to Oakland, Calif. (OAK) and the shipment is inputted into a computerized shipping-tracking system with the initial address in LAS as the destination. While the product is at sea, the seller sells the product to buyer 16 in Minneapolis, Minn. (MSP). The seller uses a package re-direct module on the shipping-tracking system to enter the buyer's address as the re-direct address.

When the product later arrives at the port of OAK, the product is unloaded and sent to a hub in nearby Sacramento (SAC). A bar-code on the package containing the product is scanned at the hub, and the package is routed to another hub at Reno (RNO). At the RNO hub, the package is again scanned, but is now sent on by truck to the re-direct address at MSP rather than to the initial address LAS. At one of the SAC, RNO, or MSP hubs a new address label is printed and attached to the package so that the local delivery truck driver in MSP can deliver the package to buyer 16.

Alternately, seller 20 sells the product by auction, with buyer 18 in Los Angeles (LAX) out-bidding buyer 16 in MSP. The seller enters the L.A. address buyer 18 as the re-direct address before the package arrives at the SAC hub, and the package is redirected from SAC to LAX by truck and delivered to buyer 18.

Although the sea link from HKG to OAK is much slower that air links from HKG, the shipping cost is much less. While the product could be sent by air to buyer 16 in MSP or buyer 18 in LAX, the shipment costs would be much higher. Since the buyer purchases the product just before it arrives in the U.S. at OAK, the shipment delay that is seen by the buyer is greatly reduced while shipment costs are also reduced.

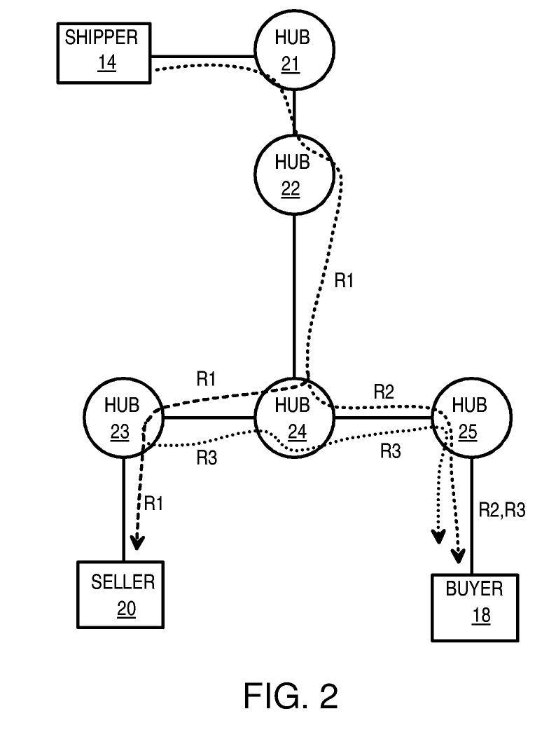

FIG. 2 is a shipment route diagram showing re-direction at different hubs. Seller 20 purchases a product from shipper 14 in China and inputs an address for seller 20 as the initial destination. The package is initially shipped over route R1 through hubs 21, 22, 24, 23, respectively. Seller 20 pays shipping charges for route R1.

While in transit, seller 20 sells the product to buyer 18. The address of buyer 18 is entered into the shipment management system as the re-direct address before the package arrives at hub 24. Hub 24 could be a U.S. port after a long sea delay from overseas hub 22. When the package arrives at hub 24, the tracking number is scanned from the package label. Hub 24 sends the tracking number to shipment management system to update shipment status, and receives the new destination address based on the tracking number. Hub 24 routes the package to route R2 toward the new destination address. Now the package is sent from hub 24 to hub 25 and then to buyer 18. The seller may pay additional shipping charges related to route R2, as well as a re-direct service charge.

Alternately, the package has already passed through hub 24 and is on the way to hub 23 when the seller enters the address of buyer 18 as the re-direct address. When the package arrives at hub 23 it is re-directed over route R3 and is not sent to seller 20. Instead, the package is sent over route R3 from hub 23 back to hub 24 and then on to hub 25 and to buyer 18. Seller 20 may pay additional shipping costs associated with back-tracking over route R3 and the re-direct service charge.

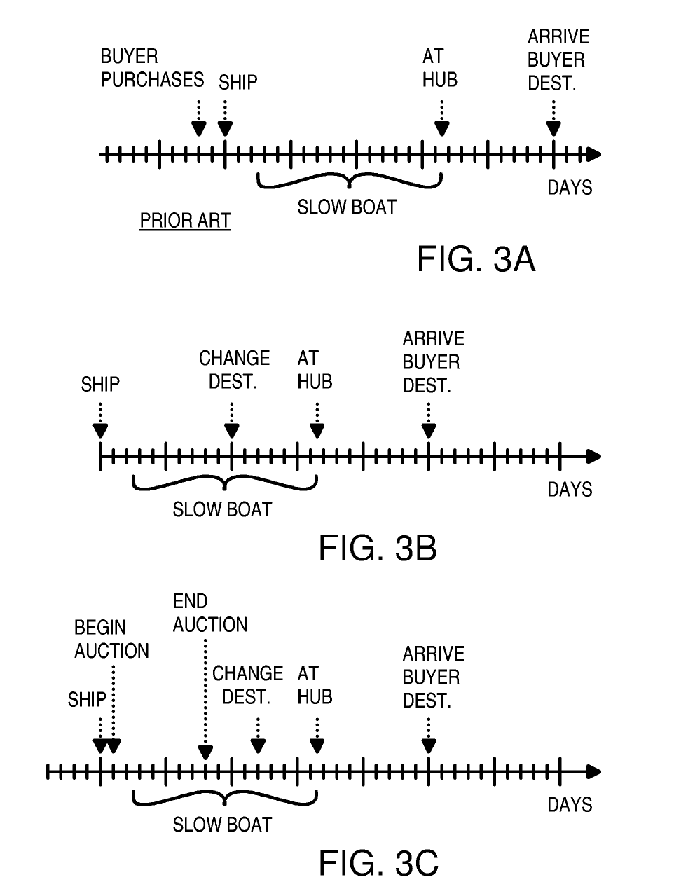

FIGS. 3A-C show shipment timelines with and without package re-direction. In FIG. 3A, without package redirection (Prior Art), the package is not shipped until the buyer orders the product. Shipment from the distributor in China occurs a few days later due to time-zone, date-zone, and other delays, and by the 4th day the package has been loaded on a container ship and the ship leaves the port in China.

The long distance traveled by the ship and the relatively slow speed of the ship result in a long delay for this slow boat from China. The container ship takes 14 days to cross the Pacific Ocean and for the containers to be unloaded from the ship and the package to be unloaded from the container and be scanned at a hub in the U.S. The buyer has been waiting for 18 days.

After another 8 days for hub delays and for trucking across the U.S., the package finally arrives at the buyer. The total transit time was 26 days.

In FIG. 3B, the seller arranges for shipment from the distributor in China and the package leaves the port in China on the third day. While the boat still adds 14 days, including unloading delays, until the package is scanned at the U.S. hub, a buyer purchases the product while the package is at sea. The destination address is changed 7 days before the package is scanned at the U.S. hub. After another 8 days of trucking across the U.S., the buyer receives the package.

The total transit time was the same in FIGS. 3A and 3B, 25 days from shipper to buyer, but in FIG. 3B the buyer only waited 15 days. The seller began shipment 10 days before the buyer purchased the product, and re-directed the package in-transit.

In FIG. 3C, the seller uses an auction such as eBay to sell the product while the product is in-transit. Online auctions are widely popular, providing a nation-wide pool of potential buyers. Online auctions typically have a specified end-of-auction date. Thus the seller can reasonably expect to sell a product using an on-line auction by the end-of-auction date, especially if the auction does not have a reserve price, and can begin shipment before the auction ends, even though no purchase has yet occurred.

In an online auction such as eBay, a buyer could be anywhere in the world. But if a shipment is in transit to the U.S., and the buyer is in Europe, the redirection costs will be much greater. Therefore, the seller may optionally specify an auction to be sold in certain markets, such as the U.S., to limit the redirect address to those areas.

The seller arranges for the shipper to ship the product to an initial destination such as the seller's warehouse or home. At a predetermined time before the product arrives at the initial destination, the seller lists the product for sale through an online auction web site. The seller sets up the auction as a 7-day auction, perhaps having a minimum selling-price or reserve.

The product is loaded onto a container ship and begins the long journey by sea. The auction ends while the package is still at sea, with the highest bidder being the buyer. After a few days for the buyer to contact the seller to complete the sale, the seller inputs the buyer's address into the shipping-tracking system as the re-direct address 4 days before the package arrives at the U.S. hub.

Upon arriving at the hub, the package is re-directed to the buyer's address. After 8 days for ground shipping across the U.S., the package arrives at the buyer's address. The buyer receives his package 13 days after completing the sale, and 17 days after the close of the auction. By comparison, the buyer would have to wait 27 days if the seller delayed initializing shipment until after the buyer completed the purchase. Re-directing the shipment resulted in a savings of 10 days.

More aggressive schedules may save more days. For example, the seller could schedule the end of the auction to occur just one day before the package arrives at the U.S. port. If the buyer were too slow in completing the sale, the package could be re-directed at a later intermediate hub. For buyers on the U.S. West Coast, the shipping times would be less than the worst-case example of 8 days for buyers in the Midwest or Eastern Seaboard. When the package is redirected to the buyer's address, more rapid and expensive shipping methods, such as by air from the U.S. port to the buyer, could also be chosen to speed up delivery to only a few days after the end of the auction.

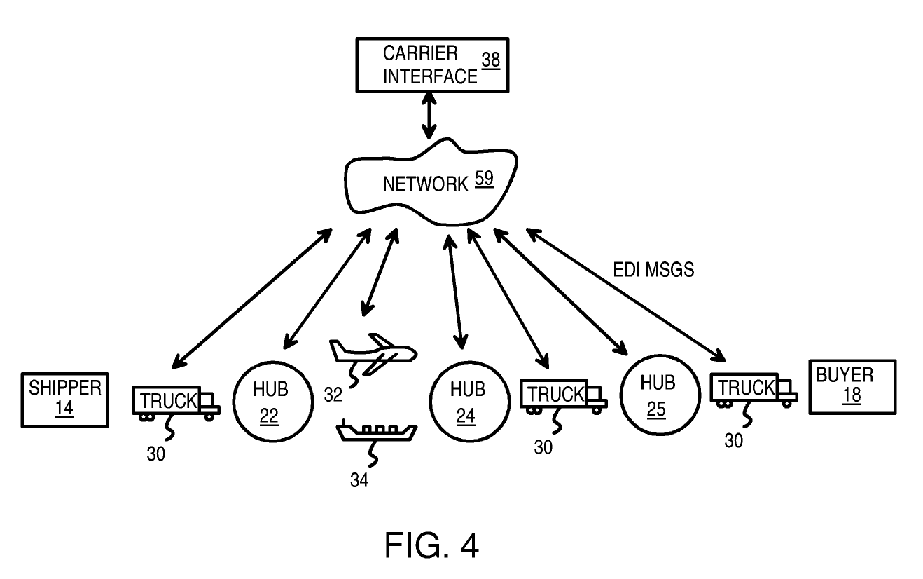

FIG. 4 shows a carrier interface to a network of carriers and hubs. More than one shipping company may be involved in the shipment, and various methods of transportation may be used, such as ground, air, or sea. For example, shipper 14 may use a local Chinese trucking company to deliver products to the port in Hong Kong for loading on ships that are run by another company. Once in the U.S., the containers unloaded from the ship may be opened by a U.S. shipper such as UPS or Fedex at their hub. The package is then carried by the U.S. carrier's trucks or airplanes to the buyer.

Carrier interface 38 may be accessed by several of these shipping companies. Network 59 may include a variety of communications networks such as the wired or wireless Internet and company Intranets. Carriers' and hubs' data systems communicate with the shipment management system through the carrier interface 38 over network 59 using Electronic Data Interchange (EDI) or other protocols. Carrier interface 38 may also interface with carrier's and hubs' web clients. Packages may be scanned at hubs 22, 24, 25 and directed to the next leg of the package's route to buyer 18. The buyer's signature may be captured upon delivery and sent over network 59 to carrier interface 38.

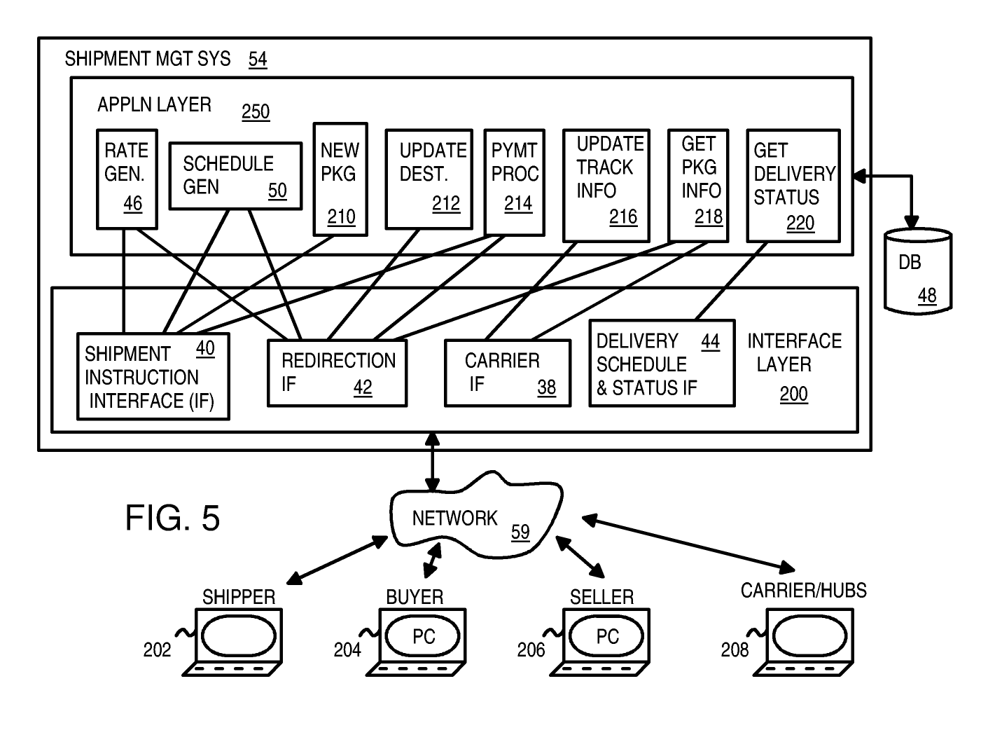

FIG. 5 shows a shipment management system that supports in-transit package re-direction. Shipment management system 54 contains software modules or objects on application layer 250 and user interfaces on interface layer 200. Network 59 connects interface layer 200 with shipper terminals 202, buyer web clients 204, seller web clients 206, and carrier and hub data systems 208. These various users can access and update shipping, tracking, and status information for packages in transit.

Shipment instruction interface 40 takes the user through the following steps to process a new shipment: 1) receiving shipping instructions from a user such as the seller, 2) allowing the user to review schedules and fees for the shipment, 3) allowing the user to confirm the shipment purchase order, and 4) allowing the user to print package labels. The shipping instructions include the initial destination address, origin, service type such as air, ground, or sea, package information such as weight, and payment information, etc. Optionally it allows the user to specify whether redirection service is desired. If yes, then show schedule of arrival dates at intermediate hubs.

Schedule generator 50 is used to generate a redirection schedule for when user should provide redirection instructions. The purpose of the redirection schedule is to inform the user when redirection instructions should be provided in order to ensure that the package can be routed to the redirect address at an intermediate hub. In the preferred embodiment, schedule generator 50 receives the shipping instructions, plots a route for the shipment, and generates an estimated schedule of the earliest arrival dates at intermediate hubs that allow for redirection. The schedule and route are based on a model of the carrier network, taking into account hub resources and schedules, carrier resources and schedules, shipment volumes and optionally dynamic information such as weather, airport delays, road accidents, etc. Optionally, resource reservations could be made for the shipment. For example, the SAC hub (FIG. 1) could be a re-directing hub that allows for package re-direction. Not all hubs have to allow for re-direction. The seller can then plan to have the product sold by that time to allow for re-direction at the desired hub. An initial delivery schedule estimate may also be generated. Rate generator 46 receives the shipping instructions and calculates the shipping fees.

As step 2 of the shipment instruction interface 40, the user reviews the shipment purchase order, including shipping instructions, estimated schedule, and shipment fees. After accepting the purchase order, payment information is sent to payment processor 214 for payment processing or billing. After payment is confirmed, the shipping instructions and schedule are sent to new package module 210, which assigns a tracking number for the shipment and creates a record for the shipment in shipping database 48. A shipping label with information such as barcode, addresses, and tracking number can be printed out and attached to the package. Alternatively, the estimated schedule is not saved in shipping database 48, but can be recreated as needed based on the shipping instructions saved in shipping database 48.

Carrier interface 38 receives tracking information from hubs and carriers when the package is scanned and may also receive Global-Positioning-Satellite (GPS) or other location information of vehicles carrying the package. The new tracking information from carrier interface 38 is used by update tracking module 216, which updates the package's record in shipping database 48. The new tracking information may also be used by get package information module 218 to retrieve shipping instructions from the shipping database 48 such as the destination address, service type, and package information. The shipping instructions are sent by carrier interface 38 to hubs so packages can be sorted, routed and moved onto trucks, ships, or planes. In the preferred embodiment, hubs make routing decisions based on the destination address on the package label or the destination address from the shipment management system. Alternatively, shipment management system may make routing decisions and provide routing instructions to hubs. Hubs may also use carrier interface 38 to check for re-direction address changes so a new address label could be applied to the package.

While the package is in transit, users can obtain tracking information through delivery schedule and status interface 44. Delivery schedule and status interface 44 activates delivery status module 220, which looks up the package's tracking record in shipping database 48. The estimated delivery date and earliest date to one or more intermediate hubs that allow re-direction may be displayed to the user by delivery schedule and status interface 44, along with other information such as the current location of the package. This tracking information may update the package's record in shipping database 48.

When a user such as the seller desires to re-direct the package, redirection interface 42 is used to take the user through the following steps: 1) inputting redirection instructions, including the new re-direct address, payment information, and optional service upgrades, 2) reviewing the new schedule and redirection fees, and 3) confirming the redirection purchase order.

After the user provides the redirection instructions, schedule generator 50 generates a new schedule of estimated earliest arrival dates at intermediate hubs that allow redirection, and optionally a new delivery date for the package, based on its current location to the redirect address. Rate generator 46 calculates the new shipping fees from the origin to the new destination and any service fees for redirection. The user is charged or credited the difference, depending on whether the new fees are greater or smaller than the fees previously paid for the shipment. Alternatively, rate generator 46 calculates the additional fees to deliver the shipment from the current location to the new destination, plus any redirection fees. The user is allowed to review the redirection purchase order, and upon acceptance, payment information is sent to payment processor 214 for payment processing or billing.

Upon payment confirmation, update destination module 212 writes the new re-direction instructions such as the redirect address, new estimated schedule, and new service type to the package's record in shipping database 48. When the package is scanned at the next intermediate hub that allows redirection, the new destination address is retrieved and the package is routed to the next hub toward the redirect address rather than toward the seller's initial address. The package could be pulled aside to affix a new label to it, or the old label with the initial address could be used until delivery. Alternately, a new label could be placed on the package at a later time such as at another hub before final delivery. If there is a hub or carrier that relies on the label to route or deliver the package correctly, then a new label must be applied before the package gets to that hub or carrier.

Delivery schedule and status interface 44 may be called up to display the new schedule and status to the user. The new schedule and status information is retrieved from shipping database 48 by delivery status module 220. Table 1 below shows an example of package status with redirection schedule as well as actual arrival events:

TABLE 1
Redirection and Actual Package Schedules

| Location | Redirection Schedule | Actual Schedule |
|---|---|---|
| HKG | 5/2 5pm | 5/2 11pm |
| OAK | 5/18 1am | In transit |
| SAC | 5/20 4am | |
| RNO | 5/21 2pm | |

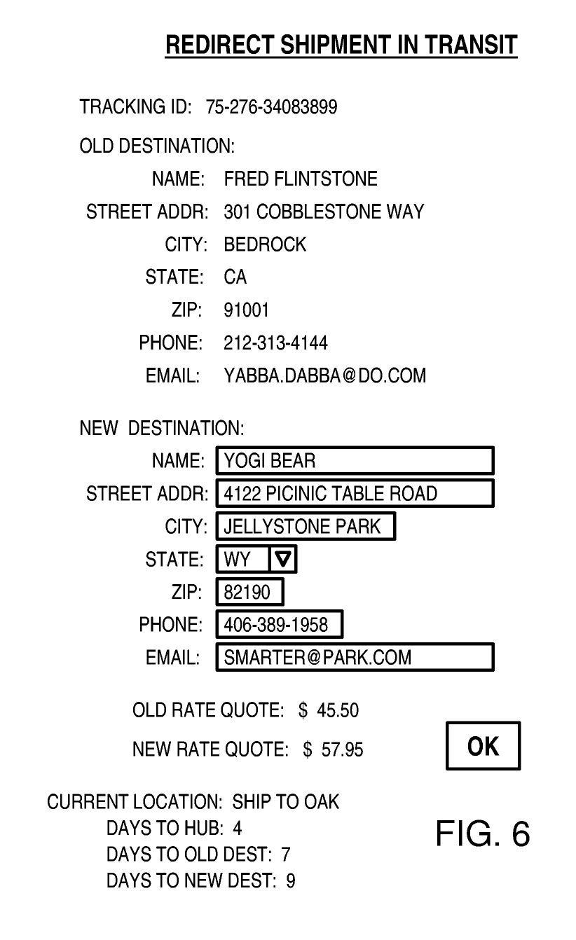

FIG. 6 shows a re-direct shipment interface. Redirection interface 42 generates a computerized form or web page such as shown in this figure to display to the user. Many other layouts are possible, multiple forms or web pages may be used, some information may be removed, and other information may be displayed.

The tracking ID for the package is displayed along with the initial destination address retrieved by get package information module 218 from shipping database 48. Other destination information such as telephone and email information may also be included.

The user can then type or paste the new destination address information into the re-direction address fields on the page. The buyer's name, address, city, state zip, phone number, and email address can all be entered.

Before calling the redirection interface 42, the current location of the package can be obtained by delivery status module 220 and displaying on the page, along with the schedule to the initial destination and to intermediate hubs that allows for re-direction. This allows the user to determine how much time is left before the package can or should be redirected. If the redirect address is entered after the package passes the intermediate hub, the package will be redirected at the next intermediate hub that allows redirection. However, some back-tracking may be necessary or a longer route may be taken and additional cost may be incurred. For example, if a package from China to the U.S. is redirected to Japan before it leaves HKG, then there may be no cost. But if the redirection to Japan takes place after it arrives in the U.S., then the cost is higher.

Once the re-direct address is entered, schedule generator 50 plots a new route for the shipment to the redirect address based on the current location of the shipment, generates a new estimated schedule of the earliest arrival dates at intermediate hubs that allow for redirection, and calculates a new estimated delivery date at the redirect address. The new estimated schedule and delivery date can be displayed to the user. Rate generator 46 can then generate the new rate quote and display it to the user. The user can click OK to accept the extra charges and approve of re-directing the package.

Some of this information may be displayed on different pages rather than on the same page as shown in this simple example. While the page displayed may be a web page displayed through a web browser, the page could also be displayed on a portable device such as a cell phone or personal digital assistant (PDA), or on a terminal for some other computer or communications system.

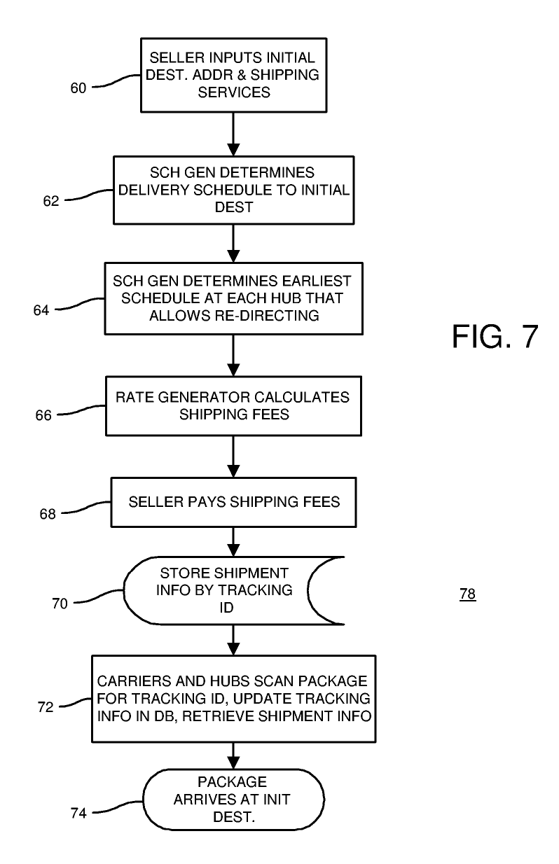

FIG. 7 is a flowchart of a shipping process without redirection. Alternative flows may also be used. Shipment process 78 begins with step 60 when a seller inputs the initial destination address, origin, service types, package information, and payment information into shipment instruction interface 40 (FIG. 5). Schedule generator 50 determines a schedule of arrival dates to intermediate hubs that allow redirection, step 62, and an initial estimated delivery date.

While the estimated delivery date at the initial destination might be worst-case or somewhat pessimistic, the hub-arrival dates are optimistic or the earliest likely date of arrival. This allows the seller to plan ahead on when to re-direct the package without missing the opportunity to redirect the shipment at the desired hub.

Rate generator 46 calculates the shipping fees to the initial destination, step 66. More complex embodiments may estimate costs if the package is re-directed at the intermediate hubs. For example, re-direction costs may be less for some intermediate hubs than for others.

Payment for the shipping fees to the initial destination is processed by payment processor 214, step 68. The shipment information, such as initial destination address, origin, package information, service type, and initial route and schedule are stored in shipping database 48, in the package's record, step 70. Records in shipping database 48 may be indexed by tracking number or by some other data key.

As the package travels from the shipper toward the initial destination, it is scanned at intermediate hubs, step 72. The package's tracking record in shipping database 48 is updated when these scans occur. Shipment information can be sent from shipping database 48 to the hub so the package can be sorted, routed, and loaded onto a truck, ship, or plane in the next leg of its route.

If redirection does not occur, the package arrives at its initial destination address, step 74. The package's record in shipping database 48 is again updated to indicate delivery, and a signature or other proof of delivery may be obtained.

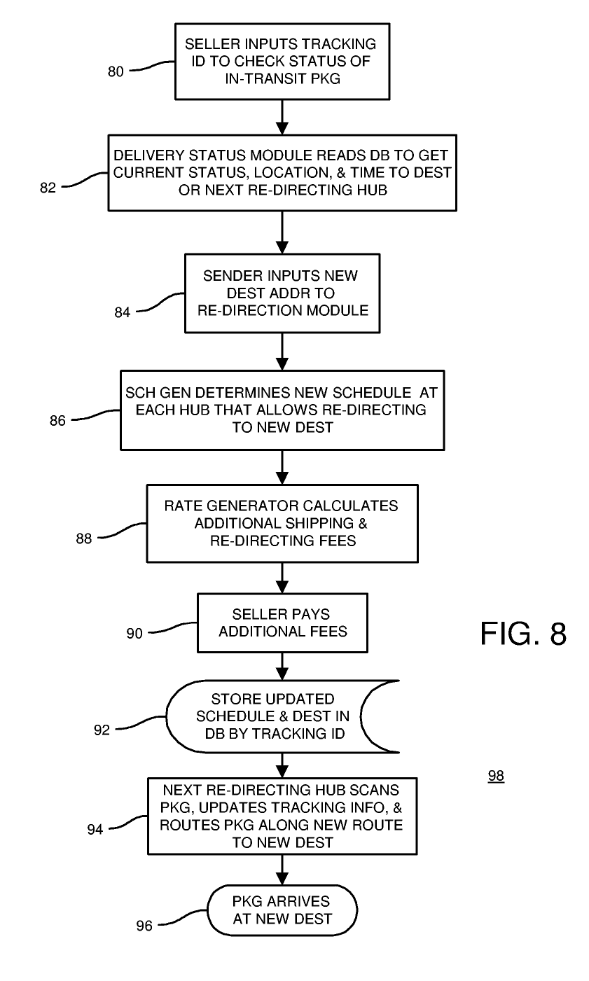

FIG. 8 is a flowchart of an in-transit redirection process. Alternative flows may also be used. Re-direction process 98 can be initiated when a user such as the seller checks the status of a package already in transit. The tracking number may be inputted or selected from a list of packages associated with the user, step 80. Delivery schedule and status interface 44 activates interface layer delivery status module 220 to read the package's record in shipping database 48 to obtain the estimated schedule to intermediate hubs, estimated delivery date, and current tracking information to display to the user, step 82. Alternatively, the time to the next re-directing hub and to the initial destination may be displayed.

The user can then call up redirection interface 42, such as by clicking on a “redirect” button on the status page. The user inputs the new destination address, optional service upgrades, and optional payment information into redirection interface 42, step 84. Schedule generator 50 plots a new route for the shipment to the redirect address based on the current location of the shipment, generates a new estimated schedule of the earliest arrival dates at intermediate hubs that allow for redirection, and calculates a new estimated delivery date at the redirect address, step 86. Alternatively, schedule generator 50 only calculates a new estimated delivery date, or schedule generator 50 is not activated at all and no new schedule is displayed to the user.

Rate generator 46 calculates the shipping fees for the new route, step 88, and displays these fees to the user, along with any service fees for using redirection. When the user reviews the new schedule and redirection fees and confirms the new purchase order, payment information is sent to payment processor 214, step 90, for payment processing or billing. After payment is processed, update destination module 212 is called to append the new destination address and update the new route and schedule to the package's record in shipping database 48, step 92. There are other ways to store the new destination information. For example, update destination module 212 may overwrite the old record with new data in the shipping database 48. However, this will result in the lost of original data. Alternatively, update destination module 212 may add a new record in shipping database 48.

When the package arrives at the next intermediate hub that allows redirection, and the package is scanned, the package's tracking record in shipping database 48 is updated, the updated shipment information is retrieved from the shipping database, and the package is sorted and routed along the new route to the redirect destination. The package continues on toward its redirected destination, step 94, until the package is delivered to the redirect address, step 96. The package may have a new label affixed to it at one of the intermediate hubs.

### Alternate Embodiments

Several other embodiments are contemplated by the inventor. For example the shipment management system may be implemented in a wide variety of ways, and with various partitionings of functions, modules, and interfaces. Data records may be stored in a variety of formats, in various table structures, and with various look-up keys in the shipping database. Centralized servers or distributed computing could be used. Redirection may be added to existing carrier shipment management systems.

There are different ways shipment instructions and redirection instructions could be entered into the shipment management system. The shipment instruction interface and redirection interface could be operated by an employee at a post office, taking shipment instructions from a customer. Shipping instructions could be provided by hand written forms from user which is scanned into the shipment management system.

In another embodiment, new package module 210 may be used instead of update destination module 212 to write the redirection instructions to shipping database 48. Before redirection interface 42 calls the new package module 210, get package information module 218 is called to retrieve the old record from the shipping database 48. New package module 210 is then called to add a new record, with the data from the old record used as default values. For example, if only redirect address is changed, new package module 210 adds a new record with the new destination address, old tracking id, old service type, and old package information. Hubs simply get the latest shipping information to route shipments. To print new address labels, hubs can check if destination address was changed by looking for a new record for the shipment.

Packages may be redirected multiple times, and may be redirected as long as package is not delivered. The redirection schedule may be updated as the shipment progresses through its route. By comparing redirection schedule versus actual schedule, shipment management system may also look for shipping or routing errors and take appropriate actions to fix. If the user knows he will not have final address in time, the user may be given an option to ask that the shipment be held at a certain intermediate hub for a longer period. Alternatively, if a user intends to redirect a shipment, the shipment may be held at certain hubs until redirection instructions are provided.

Networks can include the public Internet to allow shipping customers such as the seller and buyer to access tracking information. Networks could also include private Intranets or corporate wide-area-networks (WAN's) and local-area networks (LAN's), with web access, email, fax, instant messaging, cell phone networks such as short-messaging-service (SMS), wired and wireless networks, and various combinations. Users could also call in to a call center operated by a carrier to check status or even to input the redirect address, and the call-center operator enters the information into the carrier's system.

While scanning optical bar codes on packages at hubs has been described, radio-frequency identifier tags (RFID) or other automated tracking devices or tracking means may also be used. Other shipment information in addition to tracking number could be stored on RFID tags or address label of packages. While a single-package shipment has been described, a shipment may have several packages in the same shipment, that may be tracked and routed together, or could take different routes and have sub-order tracking numbers for each package in the shipment.

While the seller has been described as inputting the re-direct address, the buyer or other users could also enter the redirect address, either directly on the carrier interface, or through other interfaces such as through auction completion and payment web sites such as PayPal. Web application interfaces could be provided to link with other systems such as corporate shipment management systems. While the seller may pay shipping costs, other parties could pay these fees, including the buyer or the shipper. Some users could have limited access to the tracking records, such as being able to check the package status but not change the destination address.

The initial destination address could be the seller's home or business, or a warehouse contracted by the seller, or could be a holding facility by a shipping carrier that holds the package until the seller indicates a final destination address. The initial destination address does not have to be a complete address, but could be a partial address such as a country or a city. There may be holding charges for storing or delaying packages while in transit or at the seller's warehouse.

Rather than have variable fees for redirecting packages, a fixed fee could be charged for redirecting. Or the cost of redirecting packages could be included in the original shipping fees to the initial destination. If there is no fee for redirection, the rate generator in the redirection interface may not be necessary. Redirection services could be available only to certain shipping customers, such as those that do a large volume of shipping. Redirection may be more expensive when submitted after certain hubs such as initial hubs after being unloaded from ships, or when backtracking occurs. Instead of charging a user for the initial shipping rate, the user is charged a shipping rate only after shipment is redirected. In this case, the rate generator in the shipment instruction interface may not be necessary. Point-to-point rather than hub and spokes carrier networks or combination thereof, may be used. For example, packages may be transported from a hub to a shipping dock by truck, from dock to dock by ship, and from dock to hub by truck

Shipping times may vary from those described herein as examples. In general, slower route legs especially benefit from redirection during the leg, such as slow sea legs. However, priority services may also benefit. Allowing a buyer to receive a shipment in one day instead of two, by using the redirection service with two day service, results in significant cost savings since two day service costs much lower than one day service. While destinations in the U.S. have been described, the origin and destination could be anywhere, in other countries or even in other continents such as Europe, South America, Australia, etc., and the sender could be from countries other than China or places other than Asia. The invention could be applied to domestic shipping rather than international shipping.

Some hubs may not support redirection while other hubs do. The tracking number may remain the same after redirection or a new tracking number could be assigned after redirection. Hubs may check for destination address change and a new shipping label may be attached to the package at the redirecting hub or any convenient location.

A shipment may also be redirected while it is in transit on a transport link. For example, while a shipment is on a truck and redirection instructions are provided, the driver receives instructions to bring the shipment back to the departing hub.

Not all hubs and carriers need to communicate with the shipment management system. For example, some hubs may route packages based on information on the shipping label alone and may not provide scan updates. Also, some carriers only transport loads of presorted packages between hubs so it doesn't need information on individual packages. Furthermore, carriers on the final leg may use shipping label to deliver packages, and provide delivery confirmations to the carrier's data system. The carrier's data system then forwards the information to the shipment management system.

The invention is especially beneficial when the product being shipped is sold by auction on a fixed closing date and shipped by a slow delivery service before the close of the auction. By displaying optimistic estimates of arrival at intermediate hubs that support redirection, the system allows the seller to plan on redirecting before a specific time and date. The seller could be notified by email or by a cell-phone text message alert when the package needs to be redirected.

There are many ways to generate a redirection schedule for when redirection instructions should be provided. In one embodiment, a predetermined schedule based on a lookup table of geographical zones is generated and published on a web page or in print, independent of specific packages or routes. As a result, this schedule generator may not be associated with the shipment instruction interface or the redirection interface. For example, a user could lookup a printed table to learn that a shipment from China to the U.S. should be redirected in 10 days after shipping or 5 days before the delivery schedule. In another embodiment, schedule generator 50 (FIG. 5) generates a schedule for a shipment by looking up a table of predetermined schedules based on geographical zones, independent of specific packages and routes. In this case, schedule generator 50 does the table lookup for the user and the result may be displayed to the user in the shipment instruction interface and redirection interface. In yet another embodiment, schedule generator 50 generates a schedule based on the most likely or typical arrival times, or latest arrival times, or a range of arrival times, at intermediate hubs that allow redirection, rather than the earliest arrival times. In yet another embodiment, schedule generator 50 generates a schedule based on when a hub needs the shipment information to make routing decisions, since hubs may not route shipments immediately after it arrives at a hub. In yet another embodiment, schedule generator 50 generates a schedule of when a user should provide redirection instructions that is at a predetermined time before the estimated delivery date. In yet another embodiment, no schedule at intermediate hubs is provided. Shipment can be redirected at any time as long as it has not been delivered. In this case, schedule generator 50 is not required, and users can learn from experience how much time is available for redirection for certain routes. The redirection schedule can be represented in various formats, such as calendar date and time, or time remaining.

If a shipment arrives earlier than the redirection schedule at a hub, the shipment may be redirected at the next intermediate hub that allows redirection. The carrier may waive any additional fees resulting from higher shipping costs. In another embodiment, the shipment system may guarantee the user will have until the indicated time in the redirection schedule to redirect shipments by holding shipments at the hub until said indicated time if shipments arrive early.

The inventor recognizes that it is desirable to reduce the variation in arrival times at intermediate hubs that allow redirection. For example, if the earliest arrival time at hub A is 5 days while the latest arrival time is 10 days, the seller would plan to provide a redirect address 5 days after shipping the package so it can be redirected at hub A. Consequently, assuming it takes 2 days to ship a package from hub A to a redirect address, the buyer will receive the package at the earliest in 2 days and at the latest in 7 days. However, if the earliest arrival time at hub A is 9 days while the latest arrival time is 10 days, the seller would plan to provide a redirect address 9 days after shipping the package. Consequently, again assuming it takes 2 days to ship a package from hub A to a redirect address, the buyer will receive the package at the earliest in 2 days and at the latest in 3 days. Therefore, a redirection service with fixed shipping latencies, or reduced latency variation, to intermediate hubs that allow redirection is desired. In one such embodiment, schedule generator 50 generates a schedule of latest arrival dates at intermediate hubs that allow redirection, and if a shipment arrives early, it is held until the scheduled date.

In another embodiment, shipment management system may allow user to determine redirection fees based on a redirect address and the time the redirection instructions will be provided. For example, while a shipment is in transit to address A, a user could check the redirection fees if shipment is redirected to an address B two days later, five days later, and ten days later.

Web service interfaces could also be provided to link with user's data systems for any of the shipment system interfaces, such as the shipment instruction interface 40, the redirection interface 42, and the schedule and status interface 44.

Any advantages and benefits described may not apply to all embodiments of the invention. When the word “means” is recited in a claim element, Applicant intends for the claim element to fall under 35 USC Sect. 112, paragraph 6. Often a label of one or more words precedes the word “means”. The word or words preceding the word “means” is a label intended to ease referencing of claims elements and is not intended to convey a structural limitation. Such means-plus-function claims are intended to cover not only the structures described herein for performing the function and their structural equivalents, but also equivalent structures. For example, although a nail and a screw have different structures, they are equivalent structures since they both perform the function of fastening. Claims that do not use the word “means” are not intended to fall under 35 USC Sect. 112, paragraph 6. Signals are typically electronic signals, but may be optical signals such as can be carried over a fiber optic line.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An in-transit package re-directing shipment management system comprising:
a carrier interface to shipping hubs that scan packages for tracking identifiers that are sent over a communications network to the carrier interface, the shipping hubs sorting and routing packages over transportation links based on shipment information obtained over the communications network through the carrier interface in response to the tracking identifiers;
a shipment instruction interface that receives an initial destination address;
a schedule generator that generates for a package a redirection schedule having a redirection date for providing a redirect address for the package before the package is routed through an intermediate hub along a route to the initial destination address;
a shipping database for storing tracking identifiers and destination addresses;
new package module that writes the initial destination address and a tracking identifier for the package to the shipping database;
wherein the shipping hubs comprise a remote hub that routes the package over a transport link in response to initial shipping information read from the shipping database when the remote hub scans the tracking identifier from the package;
wherein the shipping hubs further comprise an intermediate hub after the transport link;
a redirection interface that receives the redirect address for the package before the package arrives at the intermediate hub;
an update destination module, coupled to the redirection interface, that writes the redirect address to the shipping database;
wherein the intermediate hub redirects the package toward the redirect address rather than toward the initial destination address,
whereby the package is redirected toward the redirect address after the transport link.

2. The in-transit package re-directing shipment management system of claim 1 wherein the transport link is a container ship traversing an ocean in not less than 7 days,
whereby the transport link is a sea link.

3. The in-transit package re-directing shipment management system of claim 1 further comprising:
a rate generator that calculates a shipping rate, the rate generator calculating a lower shipping rate when the redirection interface receives the redirect address before the package arrives at a first intermediate hub than when the redirection interface receives the redirect address after the package leaves the first intermediate hub,
whereby redirect charges are lower when the redirect address is received before the package arrives at the first intermediate hub than after the package leaves the first intermediate hub.

4. The in-transit package re-directing shipment management system of claim 3 wherein the schedule generator also generates an intermediate estimate for the package to arrive at an intermediate hub after the transport link;
a delivery schedule and status interface that displays to a user the intermediate estimate for arrival at the intermediate hub.

5. The in-transit package re-directing shipment management system of claim 4 wherein the schedule generator also generates a delivery estimate for the package to arrive at the initial destination address;
wherein the delivery schedule and status interface, coupled to read the shipping database, also displays the delivery estimate;
wherein the schedule generator generates for the package a new schedule from the intermediate hub to the redirect address.

6. The in-transit package re-directing shipment management system of claim 5 wherein the schedule generator generates the delivery estimate using a pessimistic model for delivery delays while the schedule generator generates the intermediate estimate using an optimistic model for delivery delays, the optimistic model having smaller delivery delays than the pessimistic model for a same route;
whereby the optimistic model is used to generate the intermediate estimate to the intermediate hub that redirects the package.

7. A computerized method for re-directing a package in-transit comprising:
storing a tracking identifier and an initial destination address for a package in a shipping database;
attaching an indicator of the tracking identifier to the package;
generating a redirection schedule that indicates when to provide redirection instructions;
routing the package toward the initial destination address over transportation links;
reading the indicator attached to the package and receiving information for the package from the shipping database to make routing decisions for a next transportation link at hubs;
updating tracking information for the package in the shipping database when the indicator attached to the package is read at a hub;
while the package is in transit, receiving a redirect address and storing the redirect address in the shipping database as a destination address for the package; and
routing the package toward the redirect address over transportation links rather than routing the package toward the initial destination address after the redirect address is stored in the shipping database;
whereby the package is redirected while in transit.

8. The computerized method for re-directing a package in-transit of claim 7 further comprising:
attaching a new indicator of the tracking identifier to the package after receiving the redirect address.

9. The computerized method for re-directing a package in-transit of claim 8 wherein attaching an indicator of the tracking identifier to the package comprises attaching a label with a scanable bar code indicating the tracking identifier to the package or attaching to the package a radio-frequency identifier tag (RFID) that wirelessly transmits the tracking identifier,
whereby the package is labeled or contains a RFID for tracking.

10. The computerized method for re-directing a package in-transit of claim 7 further comprising:
calculating an initial shipping rate from a shipping point of origin to the initial destination address;
calculating a redirect shipping rate to the redirect address;
charging for the redirect shipping rate,
whereby shipping rates are calculated for redirection.

11. The computerized method for re-directing a package in-transit of claim 7 further comprising a method for selling a product contained in the package by:
initiating shipment of the package before the product is sold to a buyer;
while the package is in transit, selling the product to a buyer;
after selling the product to the buyer, entering a buyer's address as the redirect address and storing the buyer's address as the redirect address in the shipping database as the destination address for the package; and
delivering the package to the buyer at the buyer's address,
whereby the product in the package is sold to the buyer while the package is in transit and redirecting the package to the buyer's address.

12. The computerized method for re-directing a package in-transit of claim 11 wherein an apparent shipping time to a buyer from selling the product to the buyer until delivering the package to the buyer is less than a shipping time of the package from a shipping point of origin to the buyer's address,
whereby apparent shipping time to the buyer is reduced.

13. The computerized method for re-directing a package in-transit of claim 12 wherein selling the product to a buyer comprises:
listing the product for sale at an online auction;
closing the online auction while the package is in transit; and
receiving the buyer's address from the buyer after the online auction is closed,
whereby the product is initially shipped before the online auction closes and the package is in transit when the online auction closes.

14. A computer-program product comprising:
a computer-usable medium having computer-executable program code means embodied therein for redirecting packages in-transit, the computer-executable program code means in the computer-program product comprising:
carrier network connection means for transmitting and receiving messages from remote shipping hubs, the messages including tracking identifiers scanned from packages passing through a shipping hub, and shipment information for the packages;
shipping database means for storing package records, a package record for a package comprising a tracking identifier and an initial destination address for the package;
initial route modeling means for generating an initial route from a shipping point of origin of the package to the initial destination address, the initial route passing through an intermediate hub;
schedule generator means for generating a redirection schedule, the redirection schedule indicating when to provide redirection instructions to permit redirection at the intermediate hub;
wherein the remote shipping hubs route the package toward the initial destination address over transportation links by scanning the package identifier and receiving shipment information for the package;
redirect means for receiving a redirect address and for storing the redirect address in the shipping database means as a destination address for the package; and
wherein the remote shipping hubs route the package toward the redirect address over transportation links by scanning the package identifier and receiving shipment information for the package, rather than routing the package toward the initial destination address after the redirect address is stored in the shipping database means;
whereby the package is redirected toward the redirect address.

15. The computer-program product of claim 14 further comprising:
rate means for calculating an initial shipping rate from a shipping point of origin to the initial destination address;
redirect rate means for calculating a redirect shipping rate for redirecting the package to the redirect address;
billing means for charging for the redirect shipping rate when redirection occurs, whereby the redirect shipping rate is calculated for redirection.

16. The computer-program product of claim 15 further comprising:
shipment initiate means for initiating shipment of a product in the package before the product is sold to a buyer;
sales means for selling the product to a buyer while the package is in transit,
wherein the redirect means receives a buyer's address as the redirect address and stores the buyer's address as the redirect address in the shipping database means as the destination address for the package while the package is in transit; and
wherein the package is delivered to the buyer at the buyer's address upon completion of routing the package to the buyer's address,
whereby the product in the package is sold to the buyer while the package is in transit and redirecting the package to the buyer's address.

17. The computer-program product of claim 16 wherein an apparent shipping time to a buyer from selling the product to the buyer until delivering the package to the buyer is less than a shipping time of the package from the shipping point of origin to the buyer's address,
whereby apparent shipping time to the buyer is reduced.

18. The computer-program product of claim 17 wherein the sales means comprises online auction means for listing the product for sale at an online auction;
wherein the sales means closing the online auction while the package is in transit; and
wherein the redirect means receives the buyer's address while the package is in transit,
whereby the product is initially shipped before the online auction closes and the package is in transit when the online auction closes.

19. A method for shipping and re-directing a package while in-transit comprising:
initiating shipment of a package by providing an initial destination address for the package to a shipment system that stores the initial destination address in a shipping database;
providing the package to a shipper that routes the package to the initial destination address;
wherein the package is provided to the shipper and the initial destination address is provided before a redirect address is available;
while the package is in transit to the initial destination address, providing the redirect address to the shipment system, the shipment system storing the redirect address in the shipping database as a new destination address for the package;
wherein the shipper routes the package toward the redirect address over transportation links rather than routes the package toward the initial destination address after the redirect address is stored in the shipping database;
further comprising a method for selling a product contained in the package by:
initiating shipment of the package before the product is sold to a buyer;
while the package is in transit, selling the product to a buyer;
after selling the product to the buyer, entering a buyer's address as the redirect address and storing the buyer's address as the redirect address in the shipping database as the new destination address for the package; and
delivering the package to the buyer at the buyer's address,
whereby the product in the package is sold to the buyer while the package is in transit and the package is redirected to the buyer's address while in transit.

20. The method for shipping and re-directing the package while in-transit of claim 19 further comprising:
the shipment system calculating a redirect shipping rate to the redirect address;
paying for the redirect shipping rate when redirection occurs,
whereby the redirect shipping rate is paid for redirection.

21. The method for shipping and re-directing the package while in-transit of claim 19 wherein routing the package toward the initial destination address over transportation links comprises transporting the package on a container ship for at least 5 days over an ocean,
whereby the package is redirected after ocean transport.

22. The method for shipping and re-directing the package while in-transit of claim 19 wherein providing the redirect address to the shipment system occurs while transporting the package on a container ship for at least 5 days over an ocean, whereby redirection occurs during a seaborne transportation link.

23. The method for shipping and re-directing the package while in-transit of claim 19 wherein an apparent shipping time to a buyer from selling the product to the buyer until delivering the package to the buyer is less than a shipping time of the package from a shipping point of origin to the buyer's address,
whereby apparent shipping time to the buyer is reduced.

24. The method for shipping and re-directing the package while in-transit of claim 23 wherein selling the product to a buyer comprises:
listing the product for sale at an online auction;
closing the online auction while the package is in transit; and
receiving the buyer's address from the buyer after the online auction is closed,
whereby the product is initially shipped before the online auction closes and the package is in transit when the online auction closes.
